(19) United States
(12) Patent Application Publication
(10) Pub. No.: US 2021/0091448 A1
(43) Pub. Date: Mar. 25, 2021

(54) ELECTRONIC DEVICE SUPPORTING THERMAL MITIGATION AND METHOD FOR CONTROLLING SAME

(71) Applicant: LG ELECTRONICS INC., Seoul (KR)

(72) Inventors: Younghee KANG, Seoul (KR); Yongbo SIM, Seoul (KR); Taeyoon KIM, Seoul (KR); Dongsu WON, Seoul (KR); Hyunmin CHO, Seoul (KR); Wonkyong CHOI, Seoul (KR)

(73) Assignee: LG ELECTRONICS INC., Seoul (KR)

(21) Appl. No.: 16/847,056

(22) Filed: Apr. 13, 2020

(30) Foreign Application Priority Data
Sep. 20, 2019 (KR) 10-2019-0116227

(51) Int. Cl. H01Q 1/00; H01Q 1/24

(52) U.S. Cl. CPC H01Q 1/002; H01Q 1/242

(57) ABSTRACT

An electronic device can include a first antenna module and a second antenna module both configured to perform wireless communication with a base station according to a first communication method; a first temperature sensor configured to detect a temperature of the first antenna module; a second temperature sensor configured to detect a temperature of the second antenna module; a memory configured to store first information related to heat dissipation characteristics of the first antenna module and second information related to heat dissipation characteristics of the second antenna module; and a modem configured to set first temperature conditions for the first antenna module based on the first information, the first temperature conditions defining a first set of thermal mitigation operations for a plurality of first temperature sections, and set second temperature conditions for the second antenna module based on the second information, the second temperature conditions defining a second set of thermal mitigation operations for a plurality of second temperature sections, in which the first temperature conditions set for the first antenna module are different than the second temperature conditions set for the second antenna module.

### CROSS-REFERENCE TO RELATED APPLICATION

Pursuant to 35 U.S.C. § 119(a), this application claims the benefit of the earlier filing date and the right of priority to Korean Patent Application No. 10-2019-0116227, filed on Sep. 20, 2019, which is incorporated by reference herein in its entirety.

### BACKGROUND

### 1. Technical Field

The present disclosure relates to an electronic device supporting fifth generation (5G) communication, and one particular implementation relates to an electronic device capable of performing 5G communication more effectively while effectively mitigating heat generated from the electronic device, and a method for controlling the same.

### 2. Description of the Related Art

Recently, various electronic devices are providing various services by virtue of commercialization of wireless communication systems using a Long-Term Evolution (LTE) communication technology. In the future, it is expected that more various services will be provided by virtue of commercialization of wireless communication systems using a 5G communication technology. Meanwhile, LTE frequency bands may be partially allocated to provide 5G communication services.

As such ultra-high speed wireless data communication is supported, electronic devices are provided with a plurality of antenna modules, and perform high-speed wireless data communications by applying higher voltages to the plurality of antenna modules. In particular, in the situation of millimeter wave (mmWave) communication using ultra-high frequencies of 30 to 300 GHz, an ultra-high speed data transmission rate can be ensured by using a high bandwidth, but a drastic temperature increase around a power amplifier (PA) is caused due to a high voltage applied to the PA.

Accordingly, studies for mitigating such a drastic temperature increase that may occur during millimeter wave (mmWave) communication are currently being actively conducted.

As part of these studies, a thermal mitigation method has been proposed. In this method, whenever temperature of an antenna module reaches a predetermined temperature, the number of antennas that form beams for the mmWave communication is reduced to mitigate heat. If heat is continuously generated, the antenna module is switched to another mmWave module. If the heat generation still continues in spite of the module switching, wireless communication is performed by a different communication scheme from the mmWave communication scheme.

In this thermal mitigation method, a specific thermal mitigation operation corresponding to a specific temperature is designated in advance. For example, when an antenna module reaches a first temperature in a normal operating state, a thermal mitigation operation according to the first temperature may be performed, and when the antenna module reaches a second temperature, a thermal mitigation operation according to the second temperature may be performed.

Meanwhile, such proposed thermal mitigation method is applied equally to a plurality of antenna modules. Therefore, without reflecting heat generation characteristics of the respective antenna modules, switching to an antenna module having a worse thermal mitigation characteristic occurs more frequently, thereby causing unnecessary antenna switching.

In addition, in the proposed thermal mitigation method, since temperatures (hereinafter, referred to as ‘change temperatures’) at which different thermal mitigation operations are performed are equally applied to the plurality of antenna modules without considering an electric field state of each antenna module, efficient 5G communication is not achieved.

### SUMMARY

This disclosure is to solve the aforementioned problems and other disadvantages. One aspect of this disclosure is to provide an electronic device, capable of more reducing the number of unnecessary module switching by lowering the probability of switching to an antenna module having a worse thermal mitigation characteristic, and a method for controlling the same.

Another aspect of this disclosure is to provide an electronic device, capable of performing more efficient 5G communication by performing a thermal mitigation operation in a different temperature condition according to an electric field state, and a method for controlling the same.

According to an aspect of the present disclosure to achieve the above or another object, an electronic device according to an implementation of the present disclosure may include a first antenna module and a second antenna module configured to perform wireless communication with a base station according to a first communication method, a temperature sensor provided in each of the first and second antenna modules and configured to detect a temperature of each antenna module, a memory configured to store information related to heat dissipation characteristics of the first antenna module and the second antenna module, and a modem configured to differently set temperature conditions differently for each of the first antenna module and the second antenna module based on the information related to the heat dissipation characteristics, the temperature conditions defining a plurality of temperature sections having different thermal mitigation operations designated thereto.

In one implementation, the heat dissipation characteristic may differ depending on at least one of a characteristic of a heat dissipation member connected to each antenna module, a structure that each antenna module is connected to the heat dissipation member, a material of another member adjacent to each antenna module, and a shape of an inner space in which each antenna module is disposed.

In one implementation, the modem may set temperature conditions for each of the first antenna module and the second antenna module such that temperature values corresponding to temperature conditions set for an antenna module having a higher heat dissipation characteristic are higher than temperature values corresponding to temperature conditions set for another antenna module having a lower heat dissipation characteristic.

In one implementation, each of the first antenna module and the second antenna module may be configured to determine an electric field state, and the temperature conditions may be differently set for each antenna module according to the electric field state determined in each antenna module.

In one implementation, the electric field state may be determined according to electric field strength measured for each antenna module, and the electric field strength may be measured according to at least one of a Received Signal Strength Indicator (RSSI), a Signal to Interference plus Noise Ratio (SINR), a Signal to Noise Ratio (SNR), or Reference Signal Received Power (RSRP), measured for each antenna module.

In one implementation, the plurality of temperature sections may include a normal operation section in which all antennas included in an antenna module are activated, a first-step temperature section to which a thermal mitigation operation to deactivate a part of the antennas included in the antenna module is designated, and a second-step temperature section to which a thermal mitigation operation to switch the antenna module to another antenna module is designated. The temperature conditions may include a first temperature condition for distinguishing the normal operation section and the first-step temperature section, and a second temperature condition for distinguishing the first-step temperature section and the second-step temperature section.

In one implementation, the modem may increase temperature values corresponding to the first temperature condition and decrease temperature values corresponding to the second temperature condition according to the determined electric field state when the determined electric field state of an antenna module is a strong electric field state. On the other hand, the modem may decrease temperature values corresponding to the first temperature condition and increase temperature values corresponding to the second temperature condition according to the determined electric field state when the determined electric field state of the antenna module is a weak electric field state.

In one implementation, a temperature section corresponding to the normal operation section may extend and the first-step temperature section may be reduced when the determined electric field state of the antenna module is a strong electric field state. On the other hand, the temperature section corresponding to the normal operation section may be reduced and the first-step temperature section may extend when the determined state of the antenna module is a weak electric field state, in response to changes in the first temperature condition and the second temperature condition.

In one implementation, the modem may determine an electric field state of an antenna module as a strong electric field when the measured electric field strength exceeds an upper limit value of a threshold interval defined based on specific electric field strength, and determine the electric field state of the antenna module as a weak electric field when the measured electric field strength is lower than a lower limit value of the threshold interval.

In one implementation, the electronic device may further include third antenna module configured to perform wireless communication according to a second communication method different from the first communication method. The modem may switch an antenna module performing wireless communication with the base station, of the first antenna module and the second antenna module, to the third antenna module to perform wireless communication with the base station according to the second communication method when a temperature detected from the antenna module performing the wireless communication with the base station is higher than or equal to a preset communication method switching temperature.

In one implementation, the first communication method may be a method of performing wireless communication with the base station according to a fifth-generation (5G) communication method using millimeter waves (mmWave). The second communication method may be a method of performing wireless communication with the base station according to the 5G communication method using a sub-6 frequency band, or a method of performing wireless communication with the base station according to a fourth-generation (4G) communication method.

In one implementation, the first antenna module may include a plurality of first antennas, a first Radio Frequency Integrated Circuit (RFIC) connected to the plurality of first antennas, and at least one first Power Amplifier (PA) disposed between the plurality of first antennas and the first RFIC. The temperature sensor provided in the first antenna module may be disposed in the first RFIC or the at least one first PA. The second antenna module may include a plurality of second antennas, a second RFIC connected to the plurality of second antennas, and at least one second PA disposed between the plurality of second antennas and the second RFIC. The temperature sensor provided in the second antenna module may be disposed in the second RFIC or the at least one second PA.

According to an aspect of the present disclosure to achieve the above or another object, a method for controlling an electronic device, which includes a first antenna module and a second antenna module capable of wireless communication with the base station according to the first communication method, according to an implementation of the present disclosure may include a first step of setting temperature conditions differently for the first antenna module and the second antenna module, based on a heat dissipation characteristic of each of the first antenna module and the second antenna module, the temperature conditions defining temperature sections having different thermal mitigation operations designated thereto, a second step of measuring a temperature of the first antenna module performing wireless communication with the base station, a third step of normally operating the first antenna module, deactivating a part of antennas of the first antenna module, or performing module switching to the second antenna module according to one temperature section according to the measured temperature, among the plurality of temperature sections defined according to the temperature conditions set for the first antenna module, a fourth step of performing wireless communication with the base station through a second antenna module and measuring a temperature of the second antenna module when the module switching to the second antenna module is performed, and a fifth step of normally operating the second antenna module, deactivating a part of antennas of the second antenna module, or performing module switching back to the first antenna module according to one temperature section according to the measured temperature, among the plurality of temperature sections defined according to the temperature conditions set for the second antenna module.

In one implementation, temperatures corresponding to temperature conditions set for an antenna module having a higher heat dissipation characteristic, of the first antenna module and the second antenna module, may be higher than temperatures corresponding to temperature conditions set for another antenna module having a lower heat dissipation characteristic.

In one implementation, the first step may include a 1-1^{th} step of measuring electric field states of the first antenna module and the second antenna module, respectively, and a 1-2^{th} step of changing the temperature conditions differently set for the respective antenna modules according to the electric field states measured in the respective antenna modules.

In one implementation, the plurality of temperature sections may include a normal operation section in which all antennas included in an antenna module are activated, a first-step temperature section to which a thermal mitigation operation to deactivate a part of the antennas included in the antenna module is designated, and a second-step temperature section to which a thermal mitigation operation to switch the antenna module to another antenna module is designated, and the temperature conditions may include a first temperature condition for distinguishing the normal operation section and the first-step temperature section, and a second temperature condition for distinguishing the first-step temperature section and the second-step temperature section.

In one implementation, the 1-2^{th} step may be performed to increase temperature values corresponding to the first temperature condition and decrease temperature values corresponding to the second temperature condition according to the determined electric field state when the determined electric field state of an antenna module is a strong electric field state. On the other hand, the 1-2 step may be performed to decrease temperature values corresponding to the first temperature condition and increase temperature values corresponding to the second temperature condition according to the determined electric field state when the determined electric field state of the antenna module is a weak electric field state.

### BRIEF DESCRIPTION OF THE DRAWINGS

FIG. 1A is a block diagram of an electronic device according to an embodiment of the present disclosure.

FIGS. 1B and 1C are views illustrating one example of an electronic device according to an embodiment of the present disclosure, viewed from different directions.

FIGS. 2A and 2B are block diagrams illustrating a configuration of a wireless communication unit of an electronic device operable in a plurality of wireless communication systems according to an embodiment of the present disclosure.

FIG. 3 is a flowchart illustrating processes of performing a thermal mitigation operation according to different temperature conditions set for each antenna module in an electronic device according to an embodiment of the present disclosure.

FIG. 4 is a view illustrating temperature conditions that are differently set according to different heat generation characteristics of respective antenna modules in an electronic device according to an embodiment of the present disclosure.

FIG. 5 is a flowchart illustrating processes of setting different temperature conditions for performing a thermal mitigation operation according to a measured electric field state in an electronic device according to an embodiment of the present disclosure.

FIG. 6 is a view illustrating an example of setting different temperature conditions when a measured electric field state is a strong electric field in an electronic device according to an embodiment of the present disclosure.

FIG. 7 is a view illustrating an example of setting different temperature conditions when a measured electric field state is a weak electric field in an electronic device according to an embodiment of the present disclosure.

### DETAILED DESCRIPTION OF THE EMBODIMENTS

Description will now be given in detail according to exemplary implementations disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Electronic devices presented herein may be implemented using a variety of different types of terminals. Examples of such devices include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of electronic devices. However, such teachings apply equally to other types of terminals, such as those types noted above. In addition, these teachings may also be applied to stationary terminals such as digital TV, desktop computers, and the like.

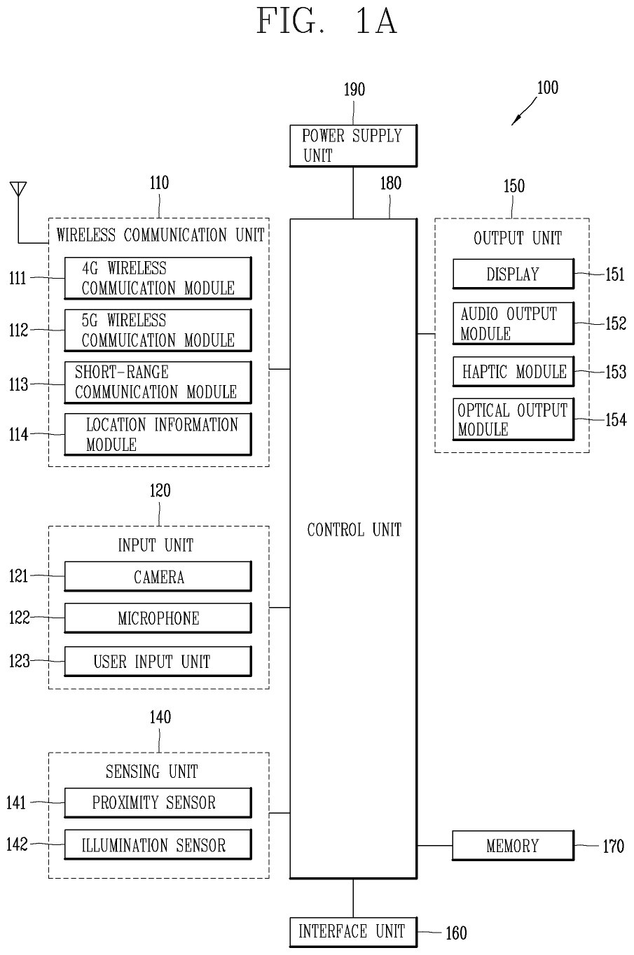

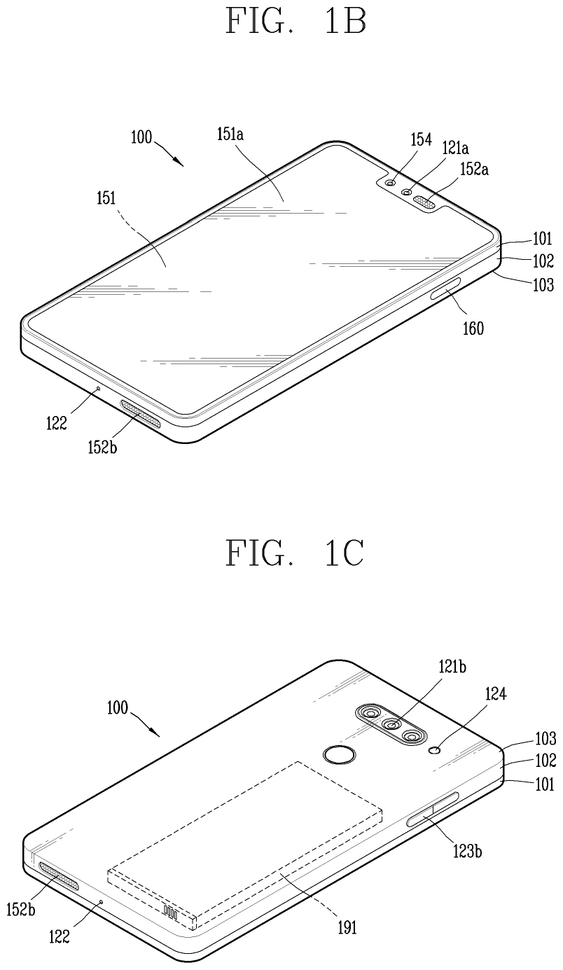

Referring to FIGS. 1A to 1C, FIG. 1A is a block diagram of an electronic device in accordance with one implementation of the present disclosure, and FIGS. 1B and 1C are conceptual views illustrating one example of an electronic device, viewed from different directions.

The electronic device 100 may be shown having components such as a wireless communication unit 110, an input unit 120, a sensing unit 140, an output unit 150, an interface unit 160, a memory 170, a controller (or control unit) 180, and a power supply unit 190. It is understood that implementing all of the illustrated components in FIG. 1A is not a requirement, and that greater or fewer components may alternatively be implemented.

In more detail, among others, the wireless communication unit 110 may typically include one or more modules which permit communications such as wireless communications between the electronic device 100 and a wireless communication system, communications between the electronic device 100 and another electronic device, or communications between the electronic device 100 and an external server. Further, the wireless communication unit 110 may typically include one or more modules which connect the electronic device 100 to one or more networks. Here, the one or more networks may be a 4G communication network and a 5G communication network, for example.

The wireless communication unit 110 may include at least one of a 4G wireless communication module 111, a 5G wireless communication module 112, a short-range communication module 113, and a location information module 114.

The 4G wireless communication module 111 may perform transmission and reception of 4G signals with a 4G base station through a 4G mobile communication network. In this situation, the 4G wireless communication module 111 may transmit at least one 4G transmission signal to the 4G base station. In addition, the 4G wireless communication module 111 may receive at least one 4G reception signal from the 4G base station.

In this regard, Uplink (UL) multi-input multi-output (MIMO) may be performed by a plurality of 4G transmission signals transmitted to the 4G base station. In addition, Downlink (DL) MIMO may be performed by a plurality of 4G reception signals received from the 4G base station.

The 5G wireless communication module 112 may perform transmission and reception of 5G signals with a 5G base station through a 5G mobile communication network. Here, the 4G base station and the 5G base station may have a Non-Stand-Alone (NSA) structure. For example, the 4G base station and the 5G base station may be a co-located structure in which the stations are disposed at the same location in a cell. Alternatively, the 5G base station may be disposed in a Stand-Alone (SA) structure at a separate location from the 4G base station.

The 5G wireless communication module 112 may perform transmission and reception of 5G signals with a 5G base station through a 5G mobile communication network. In this situation, the 5G wireless communication module 112 may transmit at least one 5G transmission signal to the 5G base station. In addition, the 5G wireless communication module 112 may receive at least one 5G reception signal from the 5G base station.

In this instance, 5G and 4G networks may use the same frequency band, and this may be referred to as LTE re-farming. Meanwhile, a Sub-6 frequency band, which is a range of 6 GHz or less, may be used as the 5G frequency band.

On the other hand, a millimeter wave (mmWave) range may be used as the 5G frequency band to perform broadband high-speed communication. When the mmWave band is used, the electronic device 100 may perform beam forming for communication coverage expansion with a base station.

On the other hand, regardless of the 5G frequency band, 5G communication systems can support a larger number of multi-input multi-output (MIMO) to improve a transmission rate. In this instance, UL MIMO may be performed by a plurality of 5G transmission signals transmitted to a 5G base station. In addition, DL MIMO may be performed by a plurality of 5G reception signals received from the 5G base station.

On the other hand, the wireless communication unit 110 may be in a Dual Connectivity (DC) state with the 4G base station and the 5G base station through the 4G wireless communication module 111 and the 5G wireless communication module 112. As such, the dual connectivity with the 4G base station and the 5G base station may be referred to as EUTRAN NR DC (EN-DC). Here, EUTRAN is an abbreviated form of “Evolved Universal Telecommunication Radio Access Network,” and refers to a 4G wireless communication system. Also, NR is an abbreviated form of “New Radio” and refers to a 5G wireless communication system.

On the other hand, if the 4G base station and 5G base station have a co-located structure, throughput improvement is achieved by inter-Carrier Aggregation (inter-CA). Accordingly, when the 4G base station and the 5G base station are disposed in the EN-DC state, the 4G reception signal and the 5G reception signal may be simultaneously received through the 4G wireless communication module 111 and the 5G wireless communication module 112.

The short-range communication module 113 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the electronic device 100 and a wireless communication system, communications between the electronic device 100 and another electronic device, or communications between the electronic device and a network where another electronic device (or an external server) is located, via wireless area networks. One example of the wireless area networks is a wireless personal area network.

Meanwhile, short-range communication between electronic devices may be performed using the 4G wireless communication module 111 and the 5G wireless communication module 112. In one implementation, short-range communication may be performed between electronic devices in a device-to-device (D2D) manner without passing through base stations.

Meanwhile, for transmission rate improvement and communication system convergence, Carrier Aggregation (CA) may be carried out using at least one of the 4G wireless communication module 111 and the 5G wireless communication module 112 and the WiFi communication module 113. In this regard, 4G+WiFi CA may be performed using the 4G wireless communication module 111 and the Wi-Fi communication module 113. Or, 5G+WiFi CA may be performed using the 5G wireless communication module 112 and the WiFi communication module 113.

The location information module 114 is a module for acquiring a position (or a current position) of the electronic device 100. As an example, the location information module 115 includes a Global Position System (GPS) module or a WiFi module. For example, when the electronic device uses the GPS module, the position of the electronic device may be acquired using a signal sent from a GPS satellite. As another example, when the electronic device uses the WiFi module, the position of the electronic device may be acquired based on information related to a wireless access point (AP) which transmits or receives a wireless signal to or from the WiFi module. If desired, the location information module 115 may alternatively or additionally function with any of the other modules of the wireless communication unit 110 to obtain data related to the position of the electronic device. The location information module 115 is a module used for acquiring the position (or the current position) of the electronic device, and may not be limited to a module for directly calculating or acquiring the position of the electronic device.

Specifically, when the electronic device utilizes the 5G wireless communication module 112, the position of the electronic device may be acquired based on information related to the 5G base station which performs radio signal transmission or reception with the 5G wireless communication module. In particular, since the 5G base station of the mmWave band is deployed in a small cell having a narrow coverage, it is advantageous to acquire the position of the electronic device.

The input unit 120 may include a camera 121 or an image input unit for obtaining images or video, a microphone 122, which is one type of audio input device for inputting an audio signal, and a user input unit 123 (for example, a touch key, a mechanical key, and the like) for allowing a user to input information. Data (for example, audio, video, image, and the like) may be obtained by the input unit 120 and may be analyzed and processed according to user commands.

The sensing unit 140 may typically be implemented using one or more sensors configured to sense internal information of the electronic device, the surrounding environment of the electronic device, user information, and the like. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like). The electronic device disclosed herein may be configured to utilize information obtained from one or more sensors of the sensing unit 140, and combinations thereof.

The output unit 150 may typically be configured to output various types of information, such as audio, video, tactile output, and the like. The output unit 150 may be shown having at least one of a display 151, an audio output module 152, a haptic module 153, and an optical output module 154. The display 151 may have an inter-layered structure or an integrated structure with a touch sensor in order to implement a touch screen. The touch screen may function as the user input unit 123 which provides an input interface between the electronic device 100 and the user and simultaneously provide an output interface between the electronic device 100 and a user.

The interface unit 160 serves as an interface with various types of external devices that are coupled to the electronic device 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some situations, the electronic device 100 may perform assorted control functions associated with a connected external device, in response to the external device being connected to the interface unit 160.

The memory 170 is typically implemented to store data to support various functions or features of the electronic device 100. For instance, the memory 170 may be configured to store application programs executed in the electronic device 100, data or instructions for operations of the electronic device 100, and the like. Some of these application programs may be downloaded from an external server via wireless communication. Other application programs may be installed within the electronic device 100 at time of manufacturing or shipping, which is typically the situation for basic functions of the electronic device 100 (for example, receiving a call, placing a call, receiving a message, sending a message, and the like). Application programs may be stored in the memory 170, installed in the electronic device 100, and executed by the controller 180 to perform an operation (or function) for the electronic device 100.

The controller 180 typically functions to control an overall operation of the electronic device 100, in addition to the operations associated with the application programs. The controller 180 may provide or process information or functions appropriate for a user by processing signals, data, information and the like, which are input or output by the aforementioned various components, or activating application programs stored in the memory 170.

Also, the controller 180 may control at least some of the components illustrated in FIG. 1A, to execute an application program that have been stored in the memory 170. In addition, the controller 180 may control at least two of those components included in the electronic device 100 to activate the application program.

Hereinafter, the controller 180 that controls the overall operation of the electronic device will be referred to as a terminal controller 180.

The power supply unit 190 may be configured to receive external power or provide internal power in order to supply appropriate power required for operating elements and components included in the electronic device 100, under the control of the terminal controller 180. The power supply unit 190 may include a battery, and the battery may be configured as an embedded battery or a detachable battery. Hereinafter, the power supply unit 190 for supplying power to each component included in the electronic device 100 will be referred to as a terminal power supply unit 190.

At least part of the components may cooperatively operate to implement an operation, a control or a control method of an electronic device according to various implementations disclosed herein. Also, the operation, the control or the control method of the electronic device may be implemented on the electronic device by an activation of at least one application program stored in the memory 170.

Referring to FIGS. 1B and 1C, the disclosed electronic device 100 includes a bar-like terminal body. However, the electronic device 100 may alternatively be implemented in any of a variety of different configurations. Examples of such configurations include watch type, clip-type, glasses-type, or a folder-type, flip-type, slide-type, swing-type, and swivel-type in which two and more bodies are combined with each other in a relatively movable manner, and combinations thereof. Discussion herein will often relate to a particular type of electronic device. However, such teachings with regard to a particular type of electronic device will generally be applied to other types of electronic devices as well.

Here, considering the electronic device 100 as at least one assembly, the terminal body may be understood as a conception referring to the assembly.

The electronic device 100 will generally include a case (for example, frame, housing, cover, and the like) forming the appearance of the terminal. In this implementation, the case is formed using a front case 101 and a rear case 102. Various electronic components are interposed into a space formed between the front case 101 and the rear case 102. At least one middle case may be additionally positioned between the front case 101 and the rear case 102.

The display 151 is shown located on the front side of the terminal body to output information. As illustrated, a window 151a of the display 151 may be mounted to the front case 101 to form the front surface of the terminal body together with the front case 101.

In some implementations, electronic components may also be mounted to the rear case 102. Examples of such electronic components include a detachable battery 191, an identification module, a memory card, and the like. In this situation, a rear cover 103 is shown covering the electronic components, and this cover may be detachably coupled to the rear case 102. Therefore, when the rear cover 103 is detached from the rear case 102, the electronic components mounted on the rear case 102 are exposed to the outside. Meanwhile, side surfaces of the rear case 102 may partially be implemented to operate as radiators.

As illustrated, when the rear cover 103 is coupled to the rear case 102, a side surface of the rear case 102 may partially be exposed. In some situations, upon the coupling, the rear case 102 may also be completely shielded by the rear cover 103. Meanwhile, the rear cover 103 may include an opening for externally exposing a camera 121b or an audio output module 152b.

The electronic device 100 may include a display 151, first and second audio output module 152a and 152b, a proximity sensor 141, an illumination sensor 142, an optical output module 154, first and second cameras 121a and 121b, first and second manipulation units 123a and 123b, a microphone 122, an interface unit 160, and the like.

The display 151 is generally configured to output information processed in the electronic device 100. For example, the display 151 may display execution screen information of an application program executing at the electronic device 100 or user interface (UI) and graphic user interface (GUI) information in response to the execution screen information.

The display 151 may be implemented using two display devices, according to the configuration type thereof. For instance, a plurality of the displays 151 may be arranged on one side, either spaced apart from each other, or these devices may be integrated, or these devices may be arranged on different surfaces.

The display 151 may include a touch sensor that senses a touch with respect to the display 151 to receive a control command in a touch manner. Accordingly, when a touch is applied to the display 151, the touch sensor may sense the touch, and the terminal controller 180 may generate a control command corresponding to the touch. Contents input in the touch manner may be characters, numbers, instructions in various modes, or a menu item that can be specified.

In this way, the display 151 may form a touch screen together with the touch sensor, and in this situation, the touch screen may function as the user input unit (123, see FIG. 1A). In some situations, the touch screen may replace at least some of functions of a first manipulation unit 123a.

The first audio output module 152a may be implemented as a receiver for transmitting a call sound to a user's ear and the second audio output module 152b may be implemented as a loud speaker for outputting various alarm sounds or multimedia playback sounds.

The optical output module 154 may be configured to output light for indicating an event generation. Examples of such events may include a message reception, a call signal reception, a missed call, an alarm, a schedule alarm, an email reception, information reception through an application, and the like. When a user has checked a generated event, the terminal controller 180 may control the optical output module 154 to stop the light output.

The first camera 121a may process image frames such as still or moving images obtained by the image sensor in a capture mode or a video call mode. The processed image frames can then be displayed on the display 151 or stored in the memory 170.

The first and second manipulation units 123a and 123b are examples of the user input unit 123, which may be manipulated by a user to provide input to the electronic device 100. The first and second manipulation units 123a and 123b may also be commonly referred to as a manipulating portion. The first and second manipulation units 123a and 123b may employ any method if it is a tactile manner allowing the user to perform manipulation with a tactile feeling such as touch, push, scroll or the like. The first and second manipulation units 123a and 123b may also be manipulated through a proximity touch, a hovering touch, and the like, without a user's tactile feeling.

On the other hand, the electronic device 100 may include a finger scan sensor which scans a user's fingerprint. The controller may use fingerprint information sensed by the finger scan sensor as an authentication means. The finger scan sensor may be installed in the display 151 or the user input unit 123.

The microphone 122 may be configured to receive the user's voice, other sounds, and the like. The microphone 122 may be provided at a plurality of places, and configured to receive stereo sounds.

The interface unit 160 may serve as a path allowing the electronic device 100 to interface with external devices. For example, the interface unit 160 may be at least one of a connection terminal for connecting to another device (for example, an earphone, an external speaker, or the like), a port for near field communication (for example, an Infrared DaAssociation (IrDA) port, a Bluetooth port, a wireless LAN port, and the like), or a power supply terminal for supplying power to the electronic device 100. The interface unit 160 may be implemented in the form of a socket for accommodating an external card, such as Subscriber Identification Module (SIM), User Identity Module (UIM), or a memory card for information storage.

The second camera 121b may be further mounted to the rear surface of the terminal body. The second camera 121b may have an image capturing direction, which is substantially opposite to the direction of the first camera unit 121a.

The second camera 121b may include a plurality of lenses arranged along at least one line. The plurality of lenses may be arranged in a matrix form. The cameras may be referred to as an ‘array camera.’ When the second camera 121b is implemented as the array camera, images may be captured in various manners using the plurality of lenses and images with better qualities may be obtained.

The flash 124 may be disposed adjacent to the second camera 121b. When an image of a subject is captured with the camera 121b, the flash 124 may illuminate the subject.

The second audio output module 152b may further be disposed on the terminal body. The second audio output module 152b may implement stereophonic sound functions in conjunction with the first audio output module 152a, and may be also used for implementing a speaker phone mode for call communication.

At least one antenna for wireless communication may be disposed on the terminal body. The antenna may be embedded in the terminal body or formed in the case. Meanwhile, a plurality of antennas connected to the 4G wireless communication module 111 and the 5G wireless communication module 112 may be disposed on side surfaces of the electronic device. Alternatively, an antenna may be formed in a form of film to be attached onto an inner surface of the rear cover 103 or a case including a conductive material may serve as an antenna.

Meanwhile, the plurality of antennas disposed on the side surfaces of the electronic device may be provided in four or more to support MIMO. In addition, when the 5G wireless communication module 112 operates in the mmWave band, each of the plurality of antennas may be implemented as an array antenna, and thus the plurality of array antennas may be disposed in the electronic device.

The terminal body is provided with a terminal power supply unit 190 (see FIG. 1A) for supplying power to the electronic device 100. The terminal power supply unit 190 may include a batter 191 which is mounted in the terminal body or detachably coupled to an outside of the terminal body.

Hereinafter, description will be given of implementations of a multi-transmission system and an electronic device having the same, specifically, a power amplifier in a heterogeneous radio system and an electronic device having the same according to the present disclosure, with reference to the accompanying drawings. It will be apparent to those skilled in the art that the present disclosure may be embodied in other specific forms without departing from the main characteristics thereof.

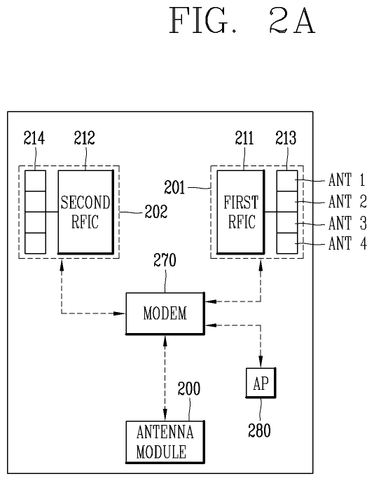

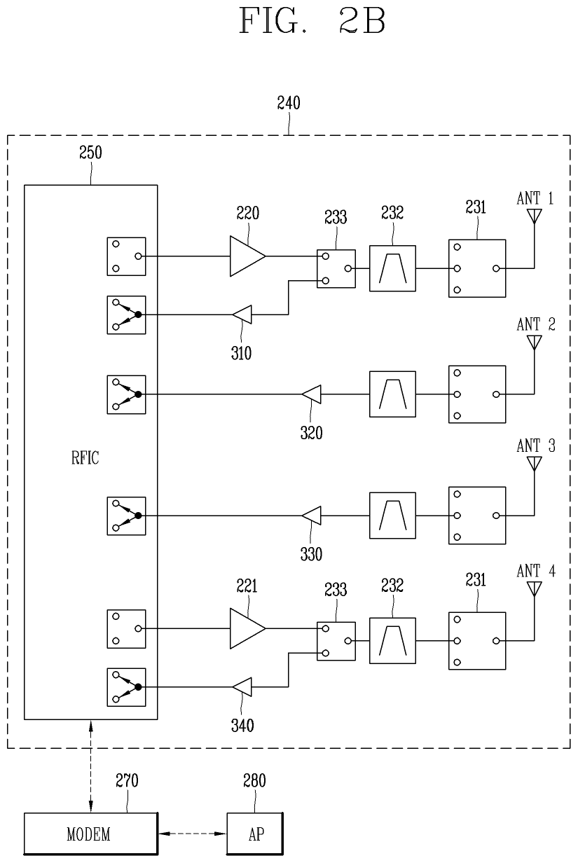

On the other hand, FIG. 2A is a block diagram illustrating a structure of a wireless communication unit 110 including a plurality of modules (hereinafter, referred to as mmWave modules) for performing wireless communication using mmWaves and a second antenna module for performing wireless communication with a base station in a different manner from the mmWave modules.

Referring to FIG. 2A, the wireless communication unit 110 of the electronic device 100 according to an implementation may include a plurality of antenna modules 201 and 202 (e.g., mmWAve antenna modules, hereinafter, referred to a first antenna module and a second antenna module) for performing broadband high-speed wireless communication using millimeter waves (mmWave), and an antenna module 200 for performing wireless communication with a base station in a different manner from the mmWave antenna modules.

The first and second antenna modules 201 and 202 may perform wireless communications using frequencies of the mmWave band. In addition, the first and second antenna modules 201 and 202 may perform higher speed wireless communications by virtue of acquisition of a wider bandwidth acquired by using the frequencies of the mmWave band than a bandwidth acquired by using frequencies of the Sub-6 band. The mmWave antenna modules 201 and 202 may perform beam forming to extend communication coverage. For this purpose, the mmWave antenna modules 201 and 202 may include antenna arrays 213 and 214, respectively, and each antenna array 213 and 214 may include a plurality of antennas. In addition, the first and second antenna modules 201 and 202 may include RFICs 211 and 212, respectively, designed for millimeter wave (mmWave) communications. Each RFIC 211 and 212 may be connected to a modem 270 and controlled by the modem 270.

The first and second antenna modules 201 and 202 may each include a temperature sensor. The temperature sensor may be provided in each RFIC or in each antenna array. Preferably, the temperature sensor may be provided in a power amplifier (PA), which may generate the most heat as a high voltage is applied. A temperature value measured by each temperature sensor may be transmitted to the modem 270 as a temperature value of each antenna module.

Meanwhile, an antenna module 200 may be at least one module that performs wireless communication with a base station in a different manner from the first and second antenna modules 201 and 202. For example, the antenna module 200 may be a 5G antenna module performing wireless communication according to a 5G communication method using a sub-6 frequency band, or a 4G antenna module performing wireless communication according to a 4G communication method. Alternatively, the antenna module 200 may be an antenna module operable by both the 4G wireless communication method or the 5G wireless communication method using the sub-6 frequency band. The antenna module 200 may perform wireless communication with the base station according to any one of the 4G wireless communication method and the wireless communication method using the sub-6 frequency band under the control of the modem 270.

An application processor (AP) 280 is configured to control an operation of each component of the electronic device. In detail, the application processor (AP) 280 may control the operation of each component of the electronic device through the modem 270.

Meanwhile, FIG. 2B illustrates a detailed configuration of an antenna module provided in the wireless communication unit 110 of the electronic device 100 according to an implementation of the present disclosure. The antenna module illustrated in FIG. 2B may be the first or second antenna module 201, 202 or the antenna module 200 operating in the different manner. However, in the situation of the first or second antenna module, a plurality of power amplifiers, RFICs, and antennas illustrated in FIG. 2B may be components for performing millimeter wave (mmWave) communication. In the situation of the another type of antenna module 200, the plurality of power amplifiers, the RFICs, and the antennas illustrated in FIG. 2B may be components for performing 4G communication or 5G communication using a sub-6 frequency band.

As illustrated in FIG. 2A, the first antenna module 201 and the second antenna module 202 may be disposed at different positions of the electronic device. Accordingly, a space where the first antenna module 201 is disposed and a space where the second antenna module 202 is disposed may have different shapes from each other. And, the first antenna module 201 and the second antenna module 202 may have different heat generation characteristics according to a difference between the disposed positions or a shape of a case where each antenna module is disposed.

For example, each of the first antenna module 201 and the second antenna module 202 may include at least one heat dissipation member to mitigate heat. However, at least one button for receiving an input from a user may be provided near one of the first antenna module 201 and the second antenna module 202. In this situation, due to a space in which the button is pushed and a space in which a circuit corresponding to the button is disposed, fewer heat dissipation members may be included in one antenna module or heat dissipation members having a smaller size or thinner thickness may be included in one antenna module. In this situation, heat dissipation characteristics of the first antenna module 201 and the second antenna module 202 may vary according to a number or area of the heat dissipation member and a structure connected to the heat dissipation member.

Meanwhile, the heat dissipation characteristics of the first antenna module 201 and the second antenna module 202 may differ depending on other adjacent components. For example, an antenna module which is located near a CPU having a temperature increasing as the electronic device is used may generate more heat than another antenna module which is not disposed near the CPU.

In addition, the heat dissipation characteristics of the first antenna module 201 and the second antenna module 202 may vary depending on a material of the heat dissipation member or a material of a member adjacent to the antenna modules. For example, when a member made of a material having a high thermal diffusion index is disposed adjacent to an antenna module, heat of the antenna module may be diffused more quickly through the adjacent member. On the other hand, when a member of a material having a low thermal diffusion index is adjacent to an antenna module, heat of the antenna module is slowly diffused through the adjacent member. Therefore, an amount of heat generated from the antenna module may increase more than an amount of heat generated from the antenna module adjacent to the member made of the high thermal diffusion index, even if they are driven for the same period of time.

That is, even though antenna modules perform wireless communications in the same manner (for example, wireless communications using the mmWave frequency band), they may have different heat dissipation characteristics due to properties of adjacent members or structural characteristics of spaces in which the antenna modules are disposed. Such heat dissipation characteristic may be determined according to a temperature-rising rate of an antenna module when wireless communication is performed under the same conditions for the same period of time. That is, an antenna module having an excellent heat dissipation characteristic, that is, an antenna module having a higher heat dissipation characteristic than other antenna modules, may be an antenna module which generates a less amount of heat than another antenna module (e.g., an antenna module having a lower heat dissipation characteristic than other antenna modules) when wireless communication is performed under the same conditions for the same period of time. That is, an antenna module having a slower temperature-rising rate may be an antenna module having an excellent heat dissipation characteristic.

Meanwhile, the heat dissipation characteristic of each antenna module may be determined according to a plurality of test results performed in relation to the heat dissipation characteristics. The determined heat dissipation characteristics may be stored in the memory 170 of the electronic device 100 according to an implementation of the present disclosure. That is, the memory 170 according to the implementation of the present disclosure may store information related to a heat radiation characteristic of each of the plurality of antenna modules for performing mmWave wireless communications. And the modem 270 of the electronic device 100 according to the implementation of the present disclosure may identify an antenna module having the best heat dissipation characteristic from among the plurality of antenna modules performing mmWave wireless communications according to the heat dissipation characteristic information stored in the memory 170.

Meanwhile, FIG. 2A exemplarily illustrates the situation where there are the two antenna modules performing mmWave wireless communications. However, the present disclosure may alternatively be applied even to a situation of including three or more antenna modules. That is, when three or more antenna modules are provided, heat radiation characteristic information related to each of the three antenna modules may be stored in the memory 170. The modem 270 may distinguish an antenna module having the best heat dissipation characteristic, and an antenna module having the second-best heat dissipation characteristic, and an antenna module having the worst heat dissipation characteristic.

Referring to FIG. 2B, the antenna module 240 of the wireless communication unit 110 according to the implementation of the present disclosure may include a first power amplifier 220, a second power amplifier 221, and an RFIC 250. In addition, the electronic device may further include a modem 270 and an application processor (AP) 280. Here, the modem 270 and the application processor 280 may be implemented physically on one chip and may be logically and functionally separated from each other. However, the present disclosure is not limited thereto and may be implemented in the form of a physically separated chip according to an application.

Meanwhile, the wireless communication unit 110 includes a plurality of low noise amplifiers (LNAs) 310 to 340 in a receiver. Here, the first power amplifier 220, the second power amplifier 221, the RFIC 250, and the plurality of LNAs 310 to 340 are all operable in the first communication system and the second communication system. For example, the first communication system and the second communication system may be a 4G communication system and a 5G communication system, respectively.

Meanwhile, the RFIC 250 may be configured as a 4G/5G integrated type, but the present disclosure is not limited thereto. The RFIC 250 may be configured as a 4G/5G separated type according to an application. When the RFIC 250 is configured as the 4G/5G integrated type, it has advantages in terms of synchronization between 4G and 5G circuits and simplification of control signaling by the modem 270.

On the other hand, when the RFIC 250 is configured as the 4G/5G separated type, the separated RFIDs may be referred to as 4G RFIC and 5G RFIC, respectively. As such, when the RFIC 250 is configured as the 4G/5G separated type, RF characteristics can be optimized for each of a 4G frequency band and a 5G frequency band. Meanwhile, even when the RFIC 250 is configured as the 4G/5G separated type, the 4G RFIC and the 5G RFIC may be logically and functionally separated from each other and may be implemented physically on one chip.

In this manner, when the RFIC 250 is configured as the 4G/5G integrated or separated type, the RFIC 250 may be configured such that the 5G RFIC using the sub-6 frequency band and the 4G RFIC may be integrated with each other or separated from each other. In this situation, the antenna module 240 illustrated in FIG. 2B may be the second antenna module that performs wireless communication according to the 4G communication method or a 5G communication method using the sub-6 frequency band.

Meanwhile, when the antenna module 240 illustrated in FIG. 2B is the first antenna module using the millimeter waves (mmWaves), the RFIC 250 may be configured by only the 5G RFIC for the mmWave 5G communication.

On the other hand, the application processor (AP) 280 is configured to control an operation of each component of the electronic device. In detail, the application processor 280 may control the operation of each component of the electronic device through the modem 270.

For example, the application processor 280 may control the modem 270 through a power management IC (PMIC) for a low power operation of the electronic device. Accordingly, the modem 270 may switch power circuits of a transmitter and a receiver to a low power mode through the RFIC 250. For example, the application processor 280 may control the RFIC 250 through the modem 270 such that at least one of power amplifiers connected to each antenna is switched to the low power mode or is turned off, based on a temperature measurement detected from the antenna module. Alternatively, the application processor 280 may control the RFIC 250 through the modem 270 to be switched to the low power mode or a sleep mode, so that a specific antenna itself can be driven in the low power mode or sleep mode.

Meanwhile, the first power amplifier 220 and the second power amplifier 221 may operate in at least one of the first and second communication systems. In this regard, when the antenna module illustrated in FIG. 2B is the second antenna module (operating in the 4G frequency band or the sub-6 frequency band), the first and second power amplifiers 221 may operate in both the first and second communication systems.

On the other hand, when the antenna module illustrated in FIG. 2B is any one of the plurality of first antenna modules (when operating in the millimeter wave (mmWave) band), the first and second power amplifiers 220 and 221 may operate in the mmWave frequency band.

Meanwhile, a transceiving antenna may be implemented by integrating a transceiver and a receiver, and thus two different wireless communication systems may be implemented using such single transceiving antenna. In this situation, 4×4 MIMO may be implemented using four antennas as illustrated in FIG. 2B. At this time, 4×4 DL MIMO may be performed through downlink (DL).

Meanwhile, when the antenna module illustrated in FIG. 2B is the second antenna module, first to fourth antennas ANT1 to ANT4 may be configured to operate in both the 4G band and the 5G band. On the other hand, when the antenna module illustrated in FIG. 2B is the first antenna module, the first to fourth antennas ANT1 to ANT4 may be configured as array antennas of millimeter wave (mmWave) band, respectively.

Meanwhile, 2×2 MIMO may be implemented using two antennas connected to the first power amplifier 220 and the second power amplifier 221 among the four antennas. At this time, 2×2 UL MIMO (2 Tx) may be performed through uplink (UL). Alternatively, the present disclosure is not limited to 2×2 UL MIMO and may alternatively be implemented using 1 Tx or 4 Tx. In this situation, when the 5G communication system is implemented using 1 Tx, only one of the first and second power amplifiers 220 and 221 may operate in the 5G communication band. Meanwhile, when the 5G communication system is implemented using 4 Tx, an additional power amplifier operating in the 5G communication band may be further provided. Alternatively, a transmission signal may be branched in each of one or two transmission paths, and the branched transmission signals may be connected to the plurality of antennas.

On the other hand, a switch-type splitter or power divider is embedded in an RFIC corresponding to the RFIC 250. Accordingly, a separate external component is not needed, thereby improving a component mounting configuration. In more detail, a single pole double throw (SPDT) type switch may be provided in the RFIC to select transmitters (TXs) of two different communication systems.

Also, the electronic device operable in the plurality of wireless communication systems according to the present disclosure may further include a duplexer 231, a filter 232, and a switch 233.

The duplexer 231 is configured to isolate signals of a transmission band and a reception band from each other. In this situation, signals of a transmission band transmitted through the first and second power amplifiers 220 and 221 may be applied to the antennas ANT1 and ANT4 through a first output port of the duplexer 231. On the other hand, signals of a reception band received through the antennas ANT1 and ANT4 may be received by the low noise amplifiers 310 to 340 through a second output port of the duplexer 231.

The filter 232 may be configured to pass signals of a transmission band or a reception band and block signals of the other bands. In this situation, the filter 232 may include a transmission filter connected to a first output port of the duplexer 231 and a reception filter connected to a second output port of the duplexer 231. Alternatively, the filter 232 may be configured to pass only the signals of the transmission band or only the signals of the reception band according to a control signal.

The switch 233 is configured to transmit only one of a transmission signal or a reception signal. In one implementation of the present disclosure, the switch 233 may be configured as a single pole double throw (SPDT) type switch to isolate a transmission signal and a reception signal from each other using a time division duplex (TDD) scheme. In this situation, the transmission signal and the reception signal are signals of the same frequency band, and thus the duplexer 231 may be implemented as a type of circulator.

In another implementation of the present disclosure, the switch 233 may also be applied to a frequency division multiplex (FDD) scheme. In this situation, the switch 233 may be configured as a double pole double throw (DPDT) type switch to connect or block a transmission signal and a reception signal. On the other hand, since the transmission signal and the reception signal can be isolated by the duplexer 231, the switch 233 is not always necessary.

Meanwhile, the electronic device according to the present disclosure may further include the modem 270 corresponding to the controller. In this situation, the RFIC 250 and the modem 270 may be referred to as a first controller (or a first processor) and a second controller (a second processor), respectively. Meanwhile, the RFIC 250 and the modem 270 may be implemented as physically isolated circuits. Alternatively, the RFIC 250 and the modem 270 may be logically or functionally distinguished from each other on one physical circuit.

The modem 270 may perform control of signal transmission and reception through different communication systems using the RFID 250 and processing of those signals. The modem 270 may receive control information from a 4G base station and/or a 5G base station. Here, the control information may be received through a physical downlink control channel (PDCCH), but the present disclosure is not limited thereto.

The modem 270 may control the RFIC 250 to transmit and/or receive signals through the first communication system and/or the second communication system at a specific time and frequency resources. Accordingly, the RFIC 250 may control transmission circuits including the first and second power amplifiers 220 and 221 to transmit a 4G signal or a 5G signal at a specific time interval. In addition, the RFIC 250 may control reception circuits including the first to fourth low noise amplifiers 310 to 340 to receive a 4G signal or a 5G signal at a specific time interval.

Hereinafter, detailed description will be given of operations and functions of the electronic device according to the present disclosure including the plurality of antenna modules as illustrated in FIG. 2B.

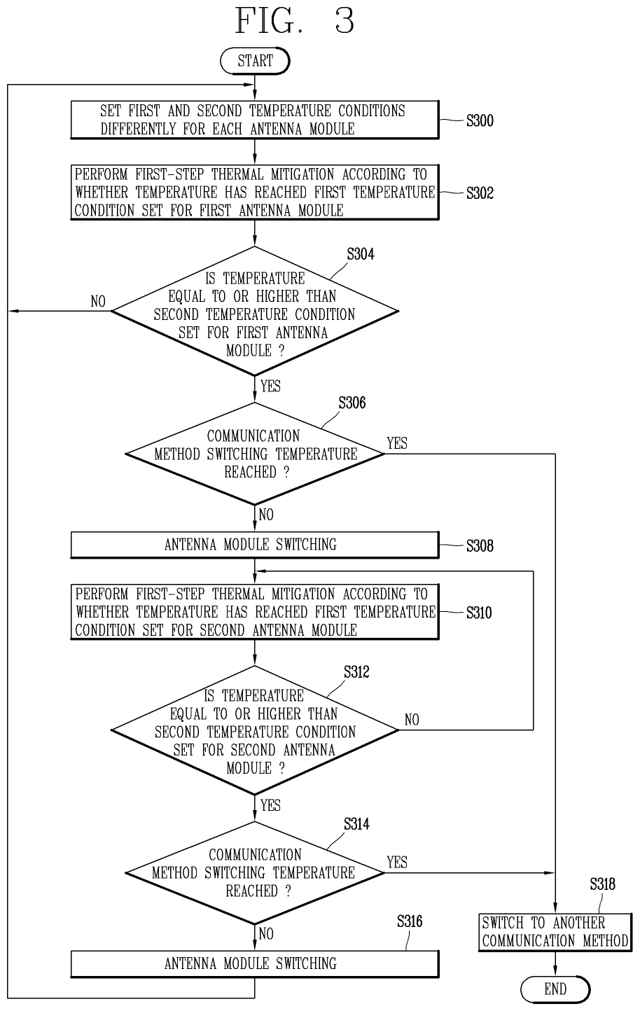

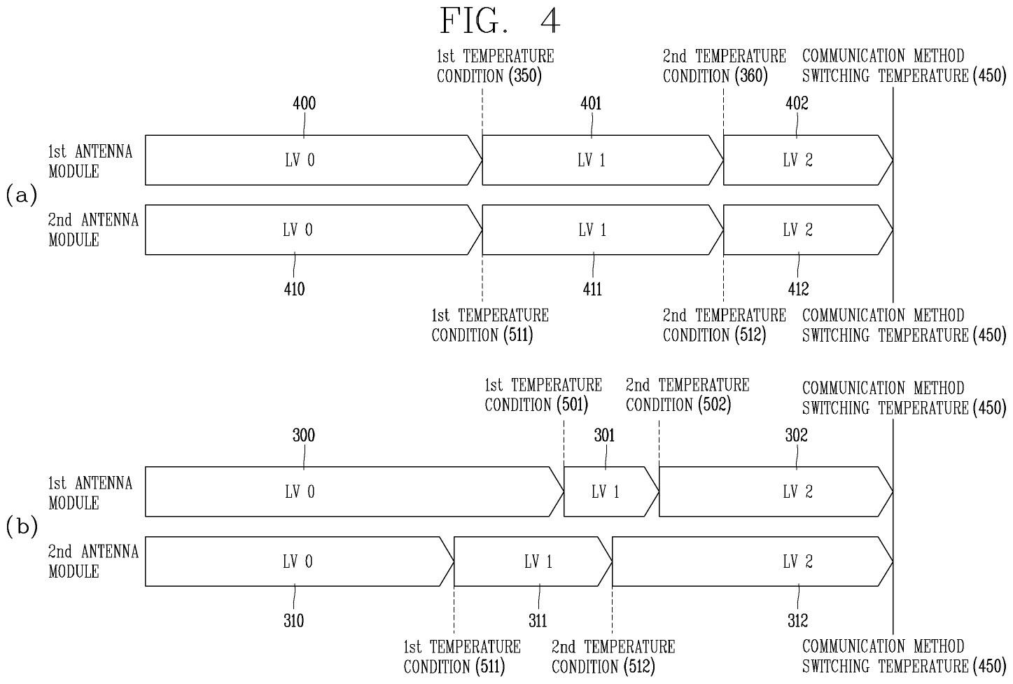

FIG. 3 is a flowchart illustrating processes of performing a thermal mitigation operation according to different temperature conditions set for each antenna module in an electronic device according to an implementation. FIG. 4 is an exemplary view illustrating temperature conditions that are differently set according to different heat generation characteristics of respective antenna modules in an electronic device according to an implementation.

Hereinafter, description will be given of an example in which an electronic device according to one implementation of the present disclosure includes two antenna modules (a first antenna module 201 and a second antenna module 202) performing wireless communications of a mmWave frequency band and an antenna module 200 performing wireless communication different from the wireless communication of the mmWave frequency band. However, of course, the present disclosure is not limited by this example. That is, of course, the present disclosure can be applied even when three or more antenna modules performing wireless communications using the mmWave frequency band are provided.

First, referring to FIG. 3, the modem 270 of the electronic device 100 according to the implementation of the present disclosure may set different temperature conditions for each antenna according to a heat dissipation characteristic of each antenna module (S300).

As described above with reference to FIG. 2A, the first and second antenna modules 201 and 202 may have different heat dissipation characteristics due the properties of adjacent members or structural characteristics of spaces in which the respective antenna module are disposed. In addition, information on the heat dissipation characteristic of each antenna module may be stored in the memory 170. Therefore, the modem 270 may identify an antenna module which has a better heat dissipation characteristic and another antenna module which does not, based on the heat dissipation characteristic information stored in the memory 170. A first temperature condition and a second temperature condition may be set differently for each antenna module according to the result of the identification.

FIG. 4 including parts (a) and (b) illustrate an example in which a first temperature condition and a second temperature condition are set equally for each antenna module in a typical electronic device, and an example in which a first temperature condition and a second temperature condition are set differently for each antenna module in an electronic device according to an implementation of the present disclosure.

First, referring to (a) of FIG. 4, which illustrates a situation of a typical electronic device, a first temperature condition 350 and a second temperature condition 360 are set equally for each antenna module. Here, a first temperature section LV 0, 400, 410 may refer to a temperature section in which the antenna module is normally driven. The state in which the antenna module is normally driven may mean a state in which all antennas of an antenna array provided in the antenna module are activated. For example, if an antenna array includes four antennas, it may mean that all of the four antennas are activated.

As illustrated in (a) of FIG. 4, in the situation where each antenna module has the same first temperature condition 350, an operation for controlling heat generation may be performed when a temperature detected from the antenna module is higher than or equal to the first temperature condition 350. In this situation, when the temperature detected from the antenna module is higher than or equal to the first temperature condition 350 (higher than or equal to the first temperature condition 350 and lower than the second temperature condition 360), the modem 270 may deactivate at least one of antennas which have been activated in the antenna module currently performing wireless communication with a base station (first-step (LV 1) thermal mitigation operation: 401, 411). In this situation, the first-step thermal mitigation operation may be performed a plurality of times according to the number of activated antennas.

For example, in the situation where an operation state in which four antennas have been activated is a normal operation state, two of the four antennas may be deactivated when the first-step thermal mitigation operation is first executed. As a result of detecting the temperature of the antenna module again, when the first-step thermal mitigation operation is performed again, one of the two antennas may be deactivated. When the only one antenna is in the activated state, the current state (the state in which the one antenna has been activated) may be maintained as long as the temperature detected from the antenna module reaches the second temperature condition 360. This is because wireless communication is disconnected when all antennas are deactivated.

On the other hand, in a situation where a temperature detected from the antenna module is higher than or equal to the second temperature condition 360 (e.g., higher than or equal to the second temperature condition 360 and lower than a communication method switching temperature 450), the modem 270 may perform antenna module switching from the antenna module currently performing the wireless communication with the base station to another antenna module performing wireless communication according to the same communication method (second-step (LV 2) thermal mitigation operation: 402, 412).

However, when the temperature detected from the antenna module is higher than or equal to the communication method switching temperature 450, the modem 270 may switch the communication method. As an example, the modem 270 may switch the antenna module to the antenna module 200 performing wireless communication according to another wireless communication method, to switch the wireless communication method. For example, when the first antenna module 201 and the second antenna module 202 are the 5G wireless communication modules using the mmWave frequency band, the modem 270 may switch those antenna modules to an antenna module (e.g., the antenna module 200) performing 5G wireless communication using the sub-6 frequency band or 4G wireless communication, to perform the 5G wireless communication of the sub-6 frequency band or the 4G wireless communication. In this situation, both the first antenna module 201 and the second antenna module 202 may be switched to a low power state, and then cooled.

On the other hand, unlike the configuration illustrated in (a) of FIG. 4, the electronic device 100 according to an embodiment of the present disclosure, as illustrated in (b) of FIG. 4, a first temperature condition and a second temperature condition may be set differently for each antenna module according to heat dissipation characteristics of the first antenna module 201 and the second antenna module 202. For convenience, in the following description, it is assumed that the first antenna module 201 has a better heat dissipation characteristic than the second antenna module 202.

Referring to (b) of FIG. 4, it may be seen that a first temperature condition 501 set in the first antenna module 201 is higher than a first temperature condition 511 set in the second antenna module 202 to widen a temperature section 300 in which the first antenna module 201 having the better heat dissipation characteristic is normally operating. Accordingly, when the second antenna module 202 is used, the first antenna module 201 may maintain a normal operation state even at a temperature at which the first-step (LV 1: 311) thermal mitigation operation is performed.

In addition, a second temperature condition 502 set in the first antenna module 201 may be set to be higher than a second temperature condition 512 set in the second antenna module 202. In this situation, a temperature section (LV 2: 302) in which a thermal mitigation operation causing antenna module switching is performed may become narrower, which may further lower the probability that the first antenna module 201 is switched to the second antenna module 202. This may result in more extending time for which the first antenna module 201 is driven.

That is, in the electronic device 100 according to the implementation of the present disclosure, temperature conditions (first temperature condition and second temperature condition) in which different thermal mitigation operations are performed may be set differently for each antenna module according to a heat dissipation characteristic of each antenna module. In addition, temperatures corresponding to respective temperature conditions set for an antenna module having an excellent heat dissipation characteristic can be higher than temperatures corresponding to temperature conditions set for an antenna module without an excellent heat dissipation characteristic. This is to allow the antenna module having the excellent heat dissipation characteristic to be driven longer and more often than the antenna module without such excellent heat dissipation characteristic.

On the other hand, in step S300, when different temperature conditions are set for each antenna module, the modem 270 may perform a thermal mitigation operation according to whether a temperature detected from an antenna module (hereinafter, assumed to the first antenna module), which is performing wireless communication with a base station, has reached the first temperature condition 501 set for the first antenna module 201 (S302).

That is, when the temperature detected from the first antenna module 201 is lower than the first temperature condition 501 (LV 0 temperature section 300), the modem 270 may control the first antenna module 201 to operate normally. However, when the temperature detected from the first antenna module 201 is higher than a temperature according to the first temperature condition 501 (hereinafter, referred to as the first temperature condition 501) ((LV 1 temperature section 301), the modem 270 may perform a thermal mitigation operation to deactivate at least one antenna.

In this situation, the normal operation may mean that all antennas of an antenna array provided in the first antenna module 201 are in an activated state, for example, four antennas are all in an activated state (LV 0: 300) if the antenna array is provided with the four antennas.

On the other hand, when the temperature detected from the first antenna module 201 is higher than or equal to the first temperature condition 501 (in the LV 1 temperature section 301), the modem 270 may deactivate at least one antenna activated in the first antenna module 201 in order to mitigate heat. In this situation, the deactivated antenna may be at least one of the antennas constituting the antenna array. The deactivation of the antenna may be performed by deactivating a PA connected to the antenna and switching the PA to a low power mode or a sleep mode.

In this situation, the gain of beams formed in the antenna array may be attenuated by the deactivated antenna. However, since currents supplied to the antenna module are reduced due to the PA deactivation, heat generation of the antenna module can be suppressed.

On the other hand, when a temperature of the first antenna module 201 continues to rise and thereby the temperature detected from the first antenna module 201 is higher than or equal to a temperature according to the second temperature condition (hereinafter, second temperature condition (502)) even though at least one antenna has been deactivated (S304), the modem 270 may determine whether the detected temperature is equal to or higher than the communication method switching temperature 450 (S306). When the detected temperature is higher than or equal to the communication method switching temperature 450, the modem 270 may switch the antenna module to the antenna module 200 using another wireless communication method, thereby switching a wireless communication method (S318).

For example, when the first antenna module 201 is the 5G wireless communication module of the mmWave frequency band, the modem 270 may switch the antenna module 201 to another antenna module (e.g., the antenna module 200) performing the 5G wireless communication using the sub-6 frequency band or the 4G wireless communication, to perform the 5G wireless communication of the sub-6 frequency band or the 4G wireless communication.

On the other hand, according to a result of the determination obtained in step S306, when the temperature detected from the first antenna module 201 is lower than the communication method switching temperature 450 (LV 2 temperature section 302), the modem 270 may perform switching to another antenna module for mitigating heat generated from the first antenna module (S308). In this situation, the another antenna module may be an antenna module that performs wireless communication with the base station in the same manner (e.g., the wireless communication using the mmWave frequency band). For example, the another antenna module may be the second antenna module 202.

Meanwhile, when the antenna module switching is performed in step S308, the modem 270 may perform wireless communication with the base station through the second antenna module 202. The first antenna module 201 may be cooled by being deactivated (e.g., switched to the low power mode) while wireless communication is performed through the second antenna module 202.

In this way, when switching to the second antenna module 202 is carried out, the modem 270 may perform a thermal mitigation operation according to whether a temperature detected from the second antenna module 202 has reached the first temperature condition 511 set for the second antenna module 202 (S310).

In step S310, when the temperature detected from the second antenna module 202 is lower than the first temperature condition 511 set for the second antenna module 202, the modem 270 may control the second antenna module 202 to operate normally.

However, when the temperature detected from the second antenna module 202 is higher than or equal to the first temperature condition 511 (LV 1 temperature section 311), the modem 270 may perform a thermal mitigation operation to deactivate at least one antenna. In this situation, the modem 270 may deactivate at least one antenna activated in the second antenna module 202 in order to mitigate heat.

On the other hand, when a temperature of the second antenna module 202 continues to rise and thereby the temperature detected from the second antenna module 202 is higher than or equal to a second temperature condition 512 even though at least one antenna has been deactivated, the modem 270 may determine whether the detected temperature is equal to or higher than the communication method switching temperature 450 (S314). When the detected temperature is higher than or equal to the communication method switching temperature 450, the modem 270 may switch the second antenna module 202 to the antenna module 200 using another wireless communication method, thereby switching a wireless communication method (S318).

On the other hand, according to a result of the determination obtained in step S314, when the temperature detected from the second antenna module 202 is lower than the communication method switching temperature 450 (LV 2 temperature section 312), the modem 270 may perform switching to another antenna module for mitigating heat generated from the second antenna module 202 (S316). In this situation, the another antenna module may be an antenna module that performs wireless communication with the base station in the same manner (e.g., the wireless communication using the mmWave frequency band) as the second antenna module. For example, the another antenna module may be the first antenna module 201.

Meanwhile, when switching to the first antenna module 201 is performed in step S316, the modem 270 may perform wireless communication with the base station through the first antenna module 201. The above-described processes may be repeated again.

On the other hand, the electronic device according to an implementation of the present disclosure may change temperature conditions according to an electric field state measured from each antenna module, in a state where a first temperature condition and a second temperature condition are differently set according to a heat dissipation characteristic of each antenna module, as aforementioned.

For example, in a strong electric field state, there may be many antennas that match transmission beams of a base station. Therefore, since data can be received through multiple antennas at the same time, a larger quantity of data can be received more quickly when more antennas are activated. On the other hand, in a weak electric field state, a small number of antennas may match the transmission beams of the base station. Therefore, an antenna module can be driven in a normal operation state (e.g., in a state where antennas provided on an antenna array are all activated) in the strong electric field state, while driven in an operation state in which at least one antenna of the antenna array is deactivated in the weak electric field state. This may result in enhancing wireless communication efficiency compared to power consumption.

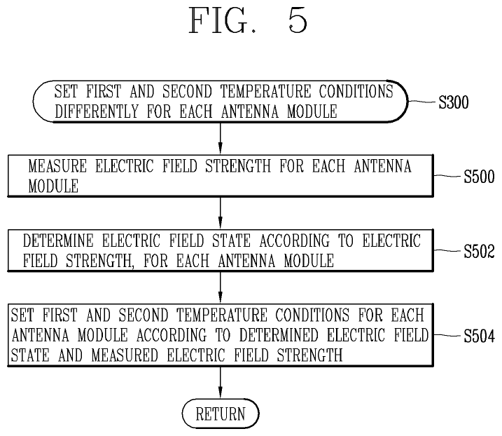

To this end, the present disclosure may measure an electric field state from each antenna module of the electronic device, and temperature conditions may be changed according to the measured electric field state, thereby enabling more efficient wireless communication. FIG. 5 is a flowchart illustrating processes of setting different temperature conditions for performing a thermal mitigation operation according to a measured electric field state in an electronic device according to an implementation.

Referring to FIG. 5, the modem 270 of the electronic device 100 according to an implementation of the present disclosure may measure electric field strength for each antenna module when the first temperature condition and the second temperature condition are set differently for each antenna module in step S300 of FIG. 3 (S500).

The electric field strength may be measured for each antenna module and may be measured based on various indices. For example, the electric field strength may be measured according to at least one of a Received Signal Strength Indicator (RSSI), a Signal to Interference plus Noise Ratio (SINR), a Signal to Noise Ratio (SNR), or Reference Signal Received Power (RSRP) measured for each antenna module.

On the other hand, when the electric field strength is measured for each antenna module in step S500, the modem 270 may determine an electric field state according to the measured electric field strength (S502). For example, the modem 270 may determine that the electric field state is a strong electric field state when the measured electric field strength exceeds a preset threshold value. On the other hand, the modem 270 may determine that the electric field state is a weak electric field state when the measured electric field strength is lower than the preset threshold value.

On the other hand, when the measured electric field strength fluctuates around the threshold value, a threshold interval may be set to prevent frequent changes of the electric field state determination result. The threshold interval may be set based on the threshold value, and a value larger than the threshold value by a preset value may be set to an upper limit value (first threshold value) and a value smaller than the threshold value by the preset value may be set to a lower limit value (second threshold value).

As an example, the threshold interval may be formed based on −90 dbm. For example, the first threshold value may be −88 dbm and the second threshold value may be −92 dbm. In this situation, the modem 270 may determine an electric field state as a strong electric field when the measured electric field strength exceeds −88 dbm, while determining the electric field as a weak electric field when the measured field strength is weaker than −92 dbm.

On the other hand, due to the threshold interval, the modem 270 may determine the electric field state of the corresponding antenna module as a strong electric field as long as the measured electric field strength is 992 dbm or higher even when the measured electric field strength is lowered to −88 dbm or lower. In addition, the modem may determine the electric field state of the corresponding antenna module as a weak electric field as long as the measured electric field strength is −88 dbm or lower even when the measured electric field strength increases to −92 dbm or higher.

When the electric field state of each antenna module is determined in step S502, the modem 270 may change the first temperature condition and the second temperature condition according to the determined electric field state (S504).

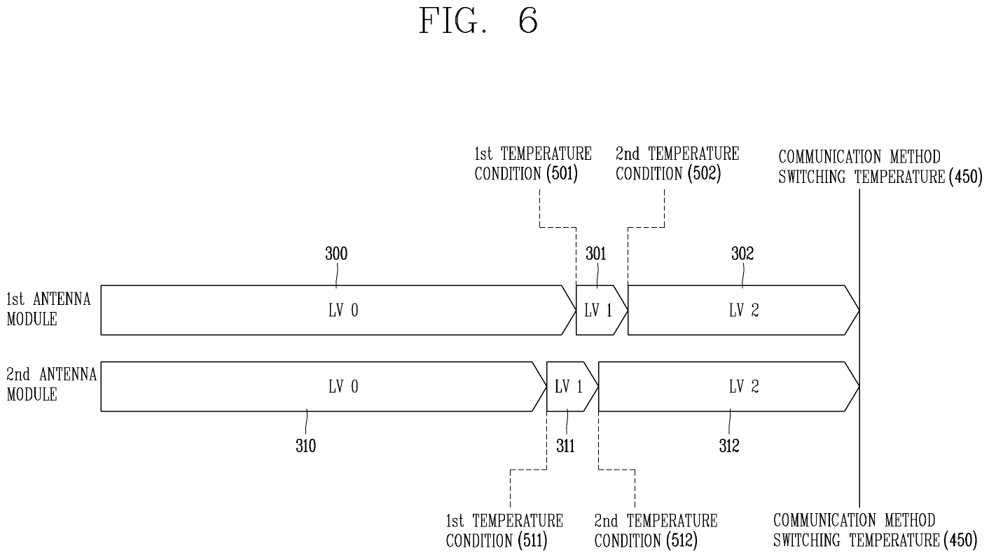

For example, in the strong electric field state, the modem 270 may increase a temperature according to the first temperature condition 501 and lower a temperature according to the second temperature condition 502. In this situation, as the temperature according to the first temperature condition 501 increases, a temperature section (LV 0 temperature section) in which the antenna module operates normally may further extend. The antenna module may maintain a normal operation state (a state in which the antennas of the antenna array are all in an activated state) even when the temperature rises slightly as the LV 0 temperature section extends. That is, a time for which the antenna module operates in the normal operation state can further extend. Hereinafter, description will be given in more detail of an example of the first temperature condition 501 and the second temperature condition 502 which are changed when a determined electric field state is a strong electric field, with reference to FIG. 6.

In this situation, the modem 270 may vary a rising width of the first temperature condition 501 (e.g., change a range or upper limit of the first temperature condition 501) and a falling width of the second temperature condition 502 (e.g., change a range or upper limit of the second temperature condition 502) according to the electric field strength measured from the antenna module. That is, a temperature corresponding to the first temperature condition 501 may be increased and a temperature of the second temperature condition 502 may be lowered as the electric field strength increases. Here, the maximum rising width of the first temperature condition 501 and the maximum falling width of the second temperature condition 502 may be limited in order to secure a minimum LV 1 temperature section.

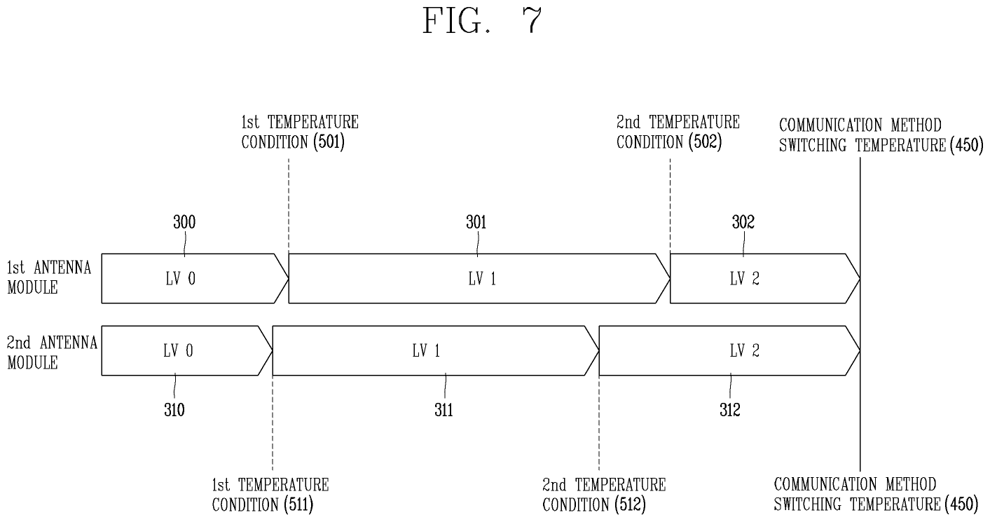

On the other hand, in the weak electric field state, the modem 270 may lower the temperature according to the first temperature condition 501 and increase the temperature according to the second temperature condition 502. In this situation, as the temperature according to the first temperature condition 501 is lowered, the temperature section (LV 0 temperature section) in which the antenna module operates normally may be reduced while the LV 1 temperature section may further extend. Therefore, instead of reducing the temperature section in which the normal operation is performed, the temperature section (LV 1 temperature section) in which a part of the antennas constituting the antenna array is deactivated may further extend. Hereinafter, description will be given in more detail of an example of the first temperature condition 501 and the second temperature condition 502 which are changed when a determined electric field state is a weak electric field, with reference to FIG. 7.

In this situation, the modem 270 may vary a falling width of the first temperature condition 501 and a rising width of the second temperature condition 502 according to an electric field strength measured from the antenna module. That is, the temperature corresponding to the first temperature condition 501 may be lowered and the temperature corresponding to the second temperature condition 502 may be increased as the electric field strength increases. Here, the maximum falling width of the first temperature condition 501 and the maximum rising width of the second temperature condition 502 may be limited in order to secure the minimum LV 0 temperature section and LV 2 temperature section.

As described above, according to the present disclosure, as illustrated in (b) of FIG. 4, temperature conditions under which different thermal mitigation operations are performed can be set differently for each antenna module according to a heat dissipation characteristic of each antenna module. In more detail, temperature conditions of an antenna module having an excellent heat dissipation characteristic may be set to be higher than those of an antenna module without such excellent heat dissipation characteristic. Therefore, if it is assumed that the first antenna module 201 has a better heat dissipation characteristic than the second antenna module 202, the first temperature condition set for the first antenna module 201 may be higher than the first temperature condition set for the second antenna module 202, and the second temperature condition set for the first antenna module may be higher than the second temperature condition set for the second antenna module.

In this state, the modem 270 of the electronic device according to the implementation of the present disclosure may change the first temperature condition and the second temperature condition set for each antenna module according to an electric field state determined for each antenna module. FIGS. 6 and 7 illustrate examples of the first temperature condition and the second temperature condition that are changed according to different electric field states.

FIG. 6 is a view illustrating an example in which a first temperature condition and a second temperature condition are changed when a measured electric field state is a strong electric field in an electronic device according to an implementation of the present disclosure.

Referring to FIG. 6, since electric field states measured from the first antenna module and the second antenna module are all strong electric fields, a temperature according to the first temperature condition 501 set for each antenna module may be set to be high. Accordingly, as illustrated in FIG. 6, temperature sections (LV 0 temperature sections: 300 and 310), in which the first and second antenna modules operate normally, respectively, may be wider than those illustrated in (b) of FIG. 4. Therefore, even when the temperature rises slightly, the first antenna module or the second antenna module may maintain the normal operation state, in which all the antennas of the antenna array are activated, for a more extended time.

On the other hand, a temperature according to the second temperature condition 502 set for each antenna module may be set to be lower. Therefore, as illustrated in FIG. 6, the temperature sections (LV 1 temperature sections: 301 and 311), in which at least one antenna is deactivated, may be narrower than those illustrated in (b) of FIG. 4. Therefore, when a temperature of an antenna module rises, the probability the antenna module is switched to another antenna module using the same communication method may become higher than the probability that some of antennas are deactivated. This is to allow for faster switching to another antenna module operating in a normal state when a temperature rises.

FIG. 7 is a view illustrating an example in which a first temperature condition and a second temperature condition are changed when a measured electric field state is a weak electric field in an electronic device according to an implementation of the present disclosure.

Referring to FIG. 7, since electric field states measured from the first antenna module and the second antenna module are all weak electric fields, a temperature according to the first temperature condition 501 set for each antenna module may be set to be low. Accordingly, as illustrated in FIG. 7, temperature sections (LV 0 temperature sections: 300 and 310), in which the first and second antenna modules operate normally, may be narrower than those illustrated in (b) of FIG. 4. Therefore, in the weak electric field state, when a temperature rises, the antenna module can more quickly enter an operation state in which at least part of antennas is deactivated (e.g., an operation state according to the LV 2 temperature section).

Also, a temperature according to the second temperature condition 502 set for each antenna module may be set to be higher. Therefore, as illustrated in FIG. 7, the temperature sections (LV 1 temperature sections: 301 and 311), in which at least one antenna is deactivated, may be wider than those illustrated in (b) of FIG. 4. This is because it can be more efficient in the weak electric field state to perform wireless communication with only a part of antennas than to perform wireless communication with all antennas activated.

Hereinafter, effects of an electronic device and a method of controlling the same according to the present disclosure will be described.

According to at least one of implementations of the present disclosure, temperatures with different thermal mitigation operations designated may be set differently for each antenna module by reflecting a heat dissipation characteristic of each antenna module performing 5G communication, thereby increasing an operation time of an antenna module having a better thermal mitigation characteristic than that of an antenna module without such excellent thermal mitigation characteristic.

According to at least one of implementations of the present disclosure, temperatures with different thermal mitigation operations designated may be set differently for each antenna module according to an electric field state determined from each antenna module performing 5G communication, thereby enabling more efficient 5G communication.

The present disclosure can be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the terminal. Therefore, the detailed description should not be limitedly construed in all of the aspects, and should be understood to be illustrative. Therefore, all changes and modifications that fall within the metes and bounds of the claims, or equivalents of such metes and bounds are therefore intended to be embraced by the appended claims.

What is claimed is:

1. An electronic device, comprising:
a first antenna module and a second antenna module both configured to perform wireless communication with a base station according to a first communication method;
a first temperature sensor configured to detect a temperature of the first antenna module;
a second temperature sensor configured to detect a temperature of the second antenna module;
a memory configured to store first information related to heat dissipation characteristics of the first antenna module and second information related to heat dissipation characteristics of the second antenna module; and
a modem configured to:
set first temperature conditions for the first antenna module based on the first information, the first temperature conditions defining a first set of thermal mitigation operations for a plurality of first temperature sections, and
set second temperature conditions for the second antenna module based on the second information, the second temperature conditions defining a second set of thermal mitigation operations for a plurality of second temperature sections,
wherein the first temperature conditions set for the first antenna module are different than the second temperature conditions set for the second antenna module.

2. The electronic device of claim 1, wherein the first antenna module includes a first antenna array including a first plurality of antennas, and
wherein the second antenna module includes a second antenna array including a second plurality of antennas.

3. The electronic device of claim 1, wherein the first temperature conditions for the first antenna module differ from the second temperature conditions for the second antenna module based on at least one of a characteristic of a heat dissipation member connected to the first or second antenna modules, a structure connected to the heat dissipation member, a material of another member adjacent to the first or second antenna modules, and a shape of an inner space in which the first or second antenna module is disposed.

4. The electronic device of claim 1, wherein the first antenna module has a higher heat dissipation characteristic than the second antenna module, and
wherein the first temperature conditions set for the first antenna module are set based on higher temperature values than the second temperature conditions set for the second antenna module.

5. The electronic device of claim 1, wherein the first antenna module is configured to determine a first electric field state of the first antenna module,
wherein the second antenna module is configured to determine a second electric field state of the second antenna module, and
wherein the first temperature conditions set for the first antenna module are set differently than the second temperature conditions set for the second antenna module based on the first and second electric field states.

6. The electronic device of claim 5, wherein the first antenna module is further configured to determine the first electric field state based on a first electric field strength measured for the first antenna module,
wherein the second antenna module is further configured to determine the second electric field state based on a second electric field strength measured for the second antenna module, and
wherein the first and second electric field strengths are measured based on at least one of a Received Signal Strength Indicator (RSSI), a Signal to Interference plus Noise Ratio (SINR), a Signal to Noise Ratio (SNR), or Reference Signal Received Power (RSRP).

7. The electronic device of claim 6, wherein the modem is further configured to:
determine the first or second electric field states as being in a strong electric field state when the first or second electric field strength exceeds a predefined upper threshold value, and
determine the first or second electric field states as being in a weak electric field state when the first or second electric field strength exceeds a predefined lower threshold value.

8. The electronic device of claim 5, wherein the plurality of first temperature sections include a normal operation section in which all of antennas within the first antenna module are in an activated state, a first-step temperature section during which one or more of the antennas within the first antenna module are placed in a deactivated state, and a second-step temperature section for determining when to switch to the second antenna module or another communication method,
wherein the first temperature conditions include a first temperature condition for transitioning from the normal operation section of the plurality of first temperature sections to the first-step temperature section of the plurality of first temperature sections, and a second temperature condition for transitioning from the first-step temperature section of the plurality of first temperature sections to the second-step temperature section of the plurality of first temperature sections,
wherein the plurality of second temperature sections include a normal operation section in which all of antennas within the second antenna module are in an activated state, a first-step temperature section during which one or more of the antennas within the second antenna module are placed in a deactivated state, and a second-step temperature section for determining when to switch to the first antenna module or another communication method, and
wherein the second temperature conditions include a first temperature condition for transitioning from the normal operation section of the plurality of second temperature sections to the first-step temperature section of the plurality of second temperature sections, and a second temperature condition for transitioning from the first-step temperature section of the plurality of second temperature sections to the second-step temperature section of the plurality of second temperature sections.

9. The electronic device of claim 8, wherein the modem is further configured to:
in response to determining that the first electric field is in a strong electric field state, increase a temperature value corresponding to the first temperature condition of the first antenna module and decrease a temperature value corresponding to the second temperature condition of the first antenna module, and
in response to determining that the second electric field is in the strong electric field state, increase a temperature value corresponding to the first temperature condition of the second antenna module and decrease a temperature value corresponding to the second temperature condition of the second antenna module.

10. The electronic device of claim 9, wherein the modem is further configured to:
in response to determining that the first electric field state of the first antenna module is in the strong electric field state, extend a temperature section corresponding to the normal operation section of the first antenna module and reduce the first-step temperature section of the first antenna module, and
in response to determining that the second electric field state of the second antenna module is in the strong electric field state, extend a temperature section corresponding to the normal operation section of the second antenna module and reduce the first-step temperature section of the second antenna module.

11. The electronic device of claim 8, wherein the modem is further configured to:
in response to determining that the first electric field is in a weak electric field state, decrease a temperature value corresponding to the first temperature condition of the first antenna module and increase a temperature value corresponding to the second temperature condition of the first antenna module, and
in response to determining that the second electric field is in the weak electric field state, decrease a temperature value corresponding to the first temperature condition of the second antenna module and increase a temperature value corresponding to the second temperature condition of the second antenna module.

12. The electronic device of claim 11, wherein the modem is further configured to:
in response to determining that the first electric field state of the first antenna module is in the weak electric field state, reduce a temperature section corresponding to the normal operation section of the first antenna module and extend the first-step temperature section of the first antenna module, and
in response to determining that the second electric field state of the second antenna module is in the weak electric field state, reduce a temperature section corresponding to the normal operation section of the second antenna module and extend the first-step temperature section of the second antenna module.

13. The electronic device of claim 1, further comprising:
a third antenna module configured to perform wireless communication according to a second communication method different from the first communication method,
wherein the modem is further configured to:
in response to detecting a temperature of one of the first or second antenna modules that is performing the wireless communication with the base station being greater than or equal to a preset communication method switching temperature, stop using the one of the first or second antenna modules to perform the wireless communication with the base station according to the first communication method and perform the wireless communication with the base station using the third antenna module according to the second communication method.

14. The electronic device of claim 13, wherein the first communication method is a fifth-generation (5G) communication method using millimeter waves (mmWave), and
wherein the second communication method is a 5G communication method using a sub-6 frequency band, or a fourth-generation (4G) communication method.

15. The electronic device of claim 1, wherein the first antenna module comprises a plurality of first antennas, a first Radio Frequency Integrated Circuit (RFIC) connected to the plurality of first antennas, and at least one first Power Amplifier (PA) disposed between the plurality of first antennas and the first RFIC,
wherein the first temperature sensor in the first antenna module is disposed in the first RFIC or the at least one first PA,
wherein the second antenna module comprises a plurality of second antennas, a second RFIC connected to the plurality of second antennas, and at least one second PA disposed between the plurality of second antennas and the second RFIC, and
wherein the second temperature sensor in the second antenna module is disposed in the second RFIC or the at least one second PA.

16. A method for controlling an electronic device including a first antenna module and a second antenna module both configured to perform wireless communication with a base station according to a first communication method, the method comprising:
setting first temperature conditions for the first antenna module and second temperature conditions different from the first temperature conditions for the second antenna module, based on a heat dissipation characteristic of each of the first antenna module and the second antenna module, the first and second temperature conditions defining temperature sections having different thermal mitigation operations;
performing the wireless communication with the base station using the first antenna module and measuring a first temperature of the first antenna module;
selecting at least one of normally operating the first antenna module, deactivating a part of antennas within the first antenna module or performing module switching to perform the wireless communication using the second antenna module or a third antenna module, based on a temperature section corresponding to the first temperature from among the temperature sections defined based on the first temperature conditions set for the first antenna module;
performing the wireless communication with the base station using the second antenna module and measuring a second temperature of the second antenna module; and
selecting at least one of normally operating the second antenna module, deactivating a part of antennas within the second antenna module or performing module switching to perform the wireless communication using the first antenna module or the third antenna module, based on a temperature section corresponding to the second temperature from among the temperature sections defined based on the second temperature conditions set for the second antenna module.

17. The method of claim 16, wherein the first antenna module has a higher heat dissipation characteristic than the second antenna module, and
wherein the first temperature conditions set for the first antenna module are set based on higher temperature values than the second temperature conditions set for the second antenna module.

18. The method of claim 16, wherein the setting the first and second temperature conditions comprises:
measuring a first electric field state of the first antenna module and measuring a second electric field state of the second antenna module; and
changing the first or second temperature conditions to be different from each other based on the first and second electric field states.

19. The method of claim 18, wherein the temperature sections defined by the first and second temperature conditions include a normal operation section in which all of antennas within the first or second antenna module are in an activated state, a first-step temperature section during which one or more of the antennas within the first or second antenna module are placed in a deactivated state, and a second-step temperature section for determining when to switch to the first, second or third antenna module, and
wherein each of the first and second temperature conditions include a first temperature condition for transitioning from the normal operation section to the first-step temperature section, and a second temperature condition for transitioning from the first-step temperature section to the second-step temperature section.

20. The method of claim 19, wherein the changing the first or second temperature conditions to be different is performed to increase a temperature value corresponding to the first temperature condition and decrease a temperature value corresponding to the second temperature condition when the first or second electric field state is a strong electric field state, and
wherein the changing the first or second temperature conditions to be different is performed to decrease a temperature value corresponding to the first temperature condition and increase a temperature value corresponding to the second temperature condition when the first or second electric field state is a weak electric field state.
